(19) United States
(12) Patent Application Publication
(10) Pub. No.: US 2026/0050083 A1
(43) Pub. Date: Feb. 19, 2026

(54) MODULAR VEHICLE LAMP HAVING BLIND SPOT DETECTION FUNCTION

(71) Applicant: VOGILI Inc., Hsinchu City (TW)

(72) Inventors: CHUN-HSIEN KUO, Hsinchu City (TW); SHIH-YU LEE, Hsinchu City (TW); YUAN-HUEI CHANG, Hsinchu City (TW)

(21) Appl. No.: 19/228,780

(22) Filed: Jun. 5, 2025

(30) Foreign Application Priority Data
Aug. 14, 2024 (TW) 113130419

(51) Int. Cl. G01S 13/931; G01S 13/86

(52) U.S. Cl. CPC G01S 13/931; G01S 13/867; G01S 2013/9315; G01S 2013/932; G01S 2013/93277

(57) ABSTRACT

A modular vehicle lamp having a blind spot detection function includes a vehicle lamp body and a blind spot detector disposed in the vehicle lamp body. The blind spot detector includes a radar detection unit and a wireless transmitting unit coupled to the radar detection unit. The radar detection unit transmits a radar detection signal to detect whether or not a moving object is present in a blind spot area of a vehicle. When the radar detection unit detects that the moving object is present in the blind spot area, the wireless transmitting unit wirelessly transmits a warning signal to an alarm of the vehicle. Accordingly, complex wiring and labor costs can be omitted.

### CROSS-REFERENCE TO RELATED PATENT APPLICATION

This application claims the benefit of priority to Taiwan Patent Application No. 113130419, filed on Aug. 14, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a vehicle lamp, and more particularly to a modular vehicle lamp having a blind spot detection function.

### BACKGROUND OF THE DISCLOSURE

A blind spot detection (BSD) system of a vehicle can generally be divided into two types that are currently available on the market: a factory-installed product and an aftermarket-installed product. The factory-installed product refers to original equipment (OE) that is in-built before the vehicle is shipped from a factory. The aftermarket-installed product is selected from various products according to individual requirements, and is installed after the vehicle is shipped from the factory. For the aftermarket (AM) blind spot detection system of the vehicle, its radar is separately installed on a vehicle body (e.g., a bumper), and its wiring also needs to be re-arranged after shipping. Therefore, complex wiring can negatively impact an aesthetic appearance of the vehicle, cause implementation difficulties, and incur high labor costs.

### SUMMARY OF THE DISCLOSURE

In response to the above-referenced technical inadequacies, the present disclosure provides a modular vehicle lamp having a blind spot detection function.

In order to solve the above-mentioned problems, one of the technical aspects adopted by the present disclosure is to provide a modular vehicle lamp having a blind spot detection function, which is adapted to be installed on a vehicle. The modular vehicle lamp includes a vehicle lamp body and a blind spot detector disposed in the vehicle lamp body. The blind spot detector includes a radar detection unit and a wireless transmitting unit coupled to the radar detection unit. The radar detection unit transmits a radar detection signal to detect whether or not a moving object is present in a blind spot area of the vehicle. When the radar detection unit detects that the moving object is present in the blind spot area, the wireless transmitting unit wirelessly transmits a warning signal to an alarm of the vehicle.

In one of the possible or preferred embodiments, the blind spot detector further includes a control unit and a movement detection unit, and the control unit is coupled to the movement detection unit, the radar detection unit, and the wireless transmitting unit. The movement detection unit detects whether or not the vehicle lamp body is moving, and transmits a wake-up signal to the control unit when the vehicle lamp body is detected to be moving. After the control unit receives the wake-up signal, the control unit controls the radar detection unit to transmit the radar detection signal, and controls the wireless transmitting unit to wirelessly transmit the warning signal to the alarm of the vehicle when the radar detection unit detects that the moving object is present in the blind spot area.

In one of the possible or preferred embodiments, the blind spot detector further includes a global positioning unit, and the control unit is coupled to the global positioning unit, the movement detection unit, the radar detection unit, and the wireless transmitting unit. After the control unit receives the wake-up signal, the control unit controls the radar detection unit to transmit the radar detection signal and simultaneously controls the global positioning unit to receive a satellite signal, and the control unit calculates a vehicle speed of the vehicle by the satellite signal received by the global positioning unit. When the vehicle speed of the vehicle is greater than or equal to a vehicle speed threshold value, the control unit controls the radar detection unit to continuously transmit the radar detection signal. When the vehicle speed of the vehicle is less than the vehicle speed threshold value, the control unit stops operation of the radar detection unit.

In one of the possible or preferred embodiments, the blind spot detector further includes an image capturing unit, and the control unit is coupled to the image capturing unit, the movement detection unit, the radar detection unit, and the wireless transmitting unit. After the control unit receives the wake-up signal, the control unit controls the radar detection unit to transmit the radar detection signal. When the radar detection unit detects that the moving object is present in the blind spot area, the control unit controls the image capturing unit to capture an image of the moving object for correspondingly generating an image signal, and controls the wireless transmitting unit to wirelessly transmit the image signal to the alarm of the vehicle.

In one of the possible or preferred embodiments, the alarm includes a wireless receiving unit, a visual warning unit, and an audio warning unit, and the wireless receiving unit is coupled to the visual warning unit and the audio warning unit. After the wireless receiving unit wirelessly receives the warning signal, the visual warning unit is controlled to transmit a visual warning message, and the audio warning unit is controlled to transmit an audio warning message.

In one of the possible or preferred embodiments, the alarm further includes a vibration warning unit, and the wireless receiving unit is coupled to the vibration warning unit, the visual warning unit, and the audio warning unit. After the wireless receiving unit wirelessly receives the warning signal, the vibration warning unit is controlled to transmit a vibration warning message.

In one of the possible or preferred embodiments, the vehicle lamp body includes at least one lighting element, the blind spot detector is positioned in an area outside of the at least one lighting element of the vehicle lamp body, and the blind spot detector is coupled to a power supply of the at least one lighting element of the vehicle lamp body.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a modular vehicle lamp according to one embodiment of the present disclosure;

FIG. 2 is a schematic view showing the modular vehicle lamp being installed on a vehicle according to one embodiment of the present disclosure;

FIG. 3 is a functional block diagram of the modular vehicle lamp according to one embodiment of the present disclosure;

FIG. 4 is a functional block diagram of the modular vehicle lamp according to one embodiment of the present disclosure;

FIG. 5 is a functional block diagram of the modular vehicle lamp according to one embodiment of the present disclosure; and

FIG. 6 is a functional block diagram of the modular vehicle lamp according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

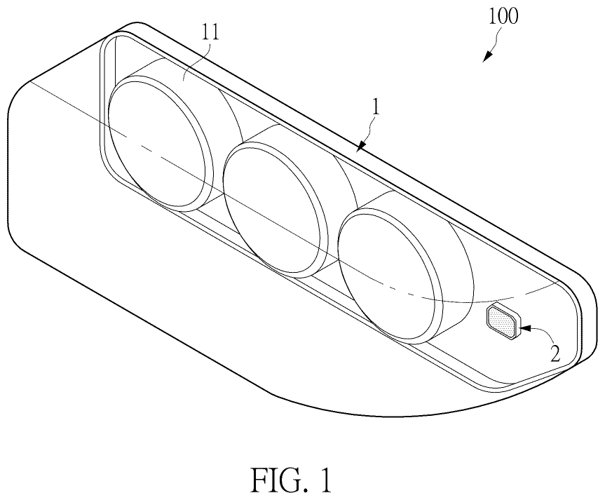

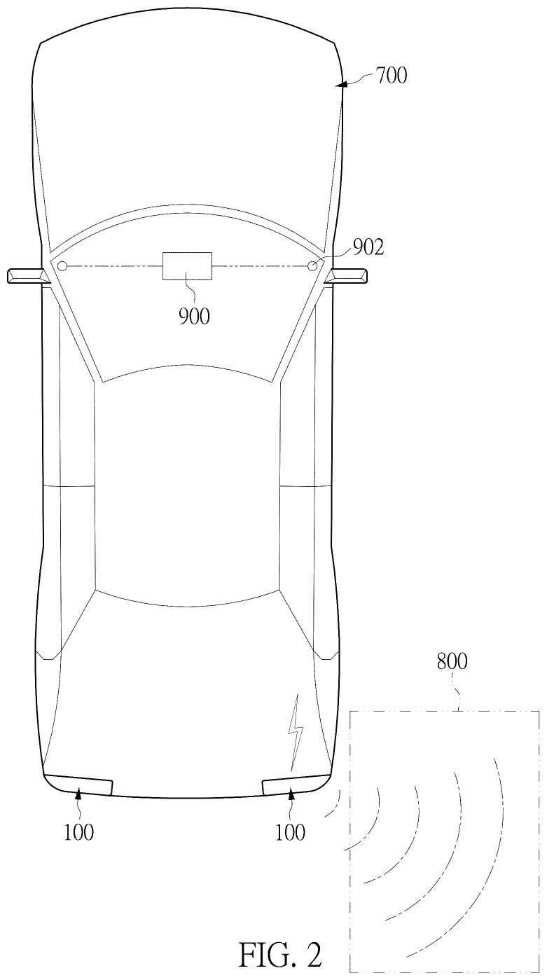

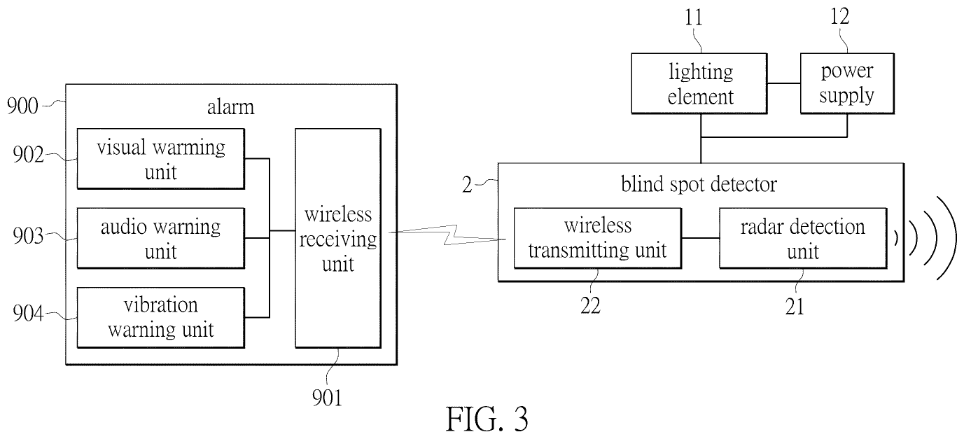

Reference is made to FIG. 1, FIG. 2, and FIG. 3. One embodiment of the present disclosure provides a modular vehicle lamp having a blind spot detection function (hereunder referred to as a modular vehicle lamp 100 for short), which is adapted to be installed on a vehicle 700. The vehicle 700 can be a car, a heavy-duty truck, a bus, etc. While two modular vehicle lamps 100 can be installed on the vehicle 700, only one modular vehicle lamp 100 is exemplified in the following descriptions for ease of illustration. The modular vehicle lamp 100 of the present embodiment essentially includes a vehicle lamp body 1 and a blind spot detector 2.

The vehicle lamp body 1 can be a tail light body that is installed at a rear side of the vehicle 700. The vehicle lamp body 1 includes at least one lighting element 11. The at least one lighting element 11 can be, for example, an LED (light-emitting diode) lamp, a high intensity discharge lamp, and a halogen lamp. Furthermore, the vehicle lamp body 1 can be an aftermarket vehicle lamp body, and its appearance and contour correspond to those of an original equipment vehicle lamp body.

The blind spot detector 2 is disposed in the vehicle lamp body 1, and is positioned in an area outside of the at least one lighting element 11 of the vehicle lamp body 1. In addition, the blind spot detector 2 is coupled to a power supply 12 of the at least one lighting element 11 of the vehicle lamp body 1, and the power supply 12 can be converted from a generator or a storage battery of the vehicle 700. As shown in FIG. 3, the blind spot detector 2 includes a radar detection unit 21 and a wireless transmitting unit 22, and the radar detection unit 21 can be activated after the vehicle 700 is started. The radar detection unit 21 transmits a radar detection signal (e.g., a millimeter wave or ultrasound) by a radar technology, and receives a corresponding reflection signal, so as to detect whether or not a moving object (e.g., an approaching vehicle from a rear side) is present in a blind spot area 800 (e.g., a rear side area of a vehicle or an inner wheel difference range when turning a heavy-duty truck) of the vehicle 700. The wireless transmitting unit 22 is coupled to the radar detection unit 21. When the radar detection unit 21 detects that the moving object is present in the blind spot area 800, the wireless transmitting unit 22 wirelessly transmits a warning signal to an alarm 900 of the vehicle 700 by a wireless transmission technology (e.g., a BLUETOOTH® technology).

The alarm 900 of the vehicle 700 can be in-built when the vehicle 700 is to be shipped from a factory, such as an in-vehicle host or a digital dashboard. The alarm 900 of the vehicle 700 can also be an aftermarket alarm, and is installed together with the modular vehicle lamp 100 as a package system on the vehicle 700 according to user requirements. As shown in FIG. 3, the alarm 900 includes a wireless receiving unit 901, a visual warning unit 902, and an audio warning unit 903. The alarm 900 can further include a vibration warning unit 904. The wireless receiving unit 901 is coupled to the visual warning unit 902, the audio warning unit 903, and the vibration warning unit 904. The wireless receiving unit 901 can be a wireless receiver that is integrated with a processor and operates in an independent manner. The wireless receiving unit 901 together with other functional units can also be controlled by a central processor of the vehicle 700, and can wirelessly receive the warning signal transmitted by the wireless transmitting unit 22 by a wireless receiving technology (e.g., the BLUETOOTH® technology). After the wireless receiving unit 901 wirelessly receives the warning signal, the visual warning unit 902 is controlled to transmit a visual warning message, the audio warning unit 903 is controlled to transmit an audio warning message, and the vibration warning unit 904 is controlled to transmit a vibration warning message. The visual warning unit 902 can be, for example, a hazard warning light or a display device, and the visual warning message can be a high brightness signal, a flashing signal, etc. The audio warning unit 903 can be, for example, a speaker or a buzzer, and the audio warning message can be an audio, a beep, etc. The vibration warning unit 904 can be, for example, a vibration motor, and the vibration warning message can be a high-frequency vibration. The alarm 900 can wirelessly receive the warning signal transmitted by the wireless transmitting unit 22 via the wireless receiving unit 901, and transmits the audio warning message, the visual warning message, or the vibration warning message via the audio warning unit 903, the visual warning unit 902, or the vibration warning unit 904, so as to achieve a blind spot warning effect. Since the modular vehicle lamp 100 of the present embodiment includes the blind spot detector 2, and the blind spot detector 2 of the modular vehicle lamp 100 achieves the blind spot warning effect by adopting the wireless transmission technology to transmit the warning signal to the alarm 900 of the vehicle 700, complex wiring can be omitted, and implementation difficulties and labor costs can be effectively reduced.

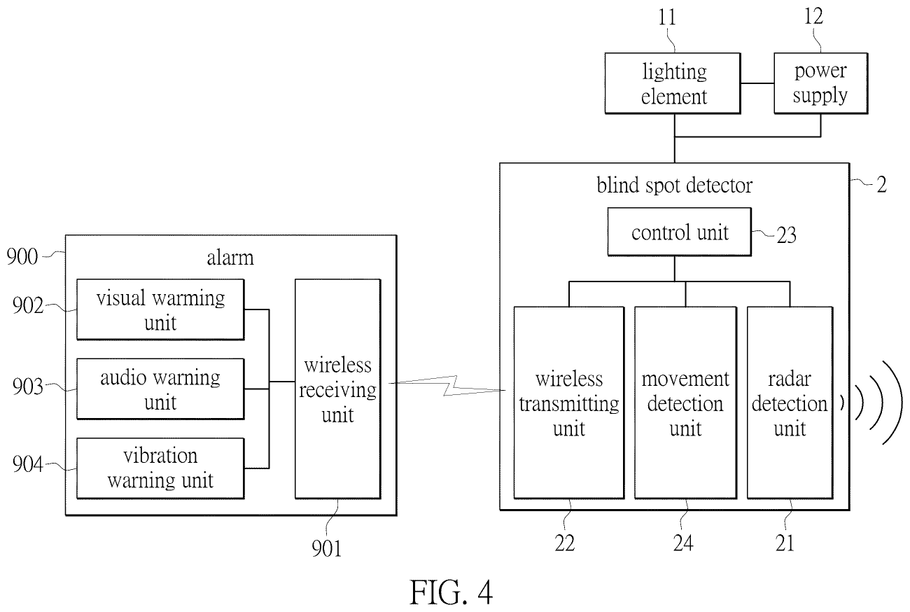

Reference is made to FIG. 1 and FIG. 2, which are to be read in conjunction with FIG. 4. In one embodiment, the blind spot detector 2 of the modular vehicle lamp 100 can further include a control unit 23 and a movement detection unit 24. The control unit 23 is coupled to the movement detection unit 24, the radar detection unit 21, and the wireless transmitting unit 22. The movement detection unit 24 can include one or a combination of a three-axis accelerometer and a three-axis gyroscope, so as to detect whether or not the vehicle lamp body 1 (i.e., the vehicle 700) is moving. When the vehicle lamp body 1 is detected to be moving, the movement detection unit 24 transmits a wake-up signal to the control unit 23. The control unit 23 can be, for example, a microcontroller unit (MCU) having a logic program, and controls the radar detection unit 21 to transmit the radar detection signal after receipt of the wake-up signal. When the radar detection unit 21 detects that the moving object is present in the blind spot area 800 of the vehicle 700, the control unit 23 controls the wireless transmitting unit 22 to wirelessly transmit the warning signal to the alarm 900 of the vehicle 700. As such, when the vehicle 700 starts moving, the modular vehicle lamp 100 can detect movement of the vehicle 700 and activate a radar detection function for detecting whether or not the moving object is present in the blind spot area 800 of the vehicle 700, and wirelessly transmits the warning signal to the alarm 900 of the vehicle 700 when the moving object is detected to be present in the blind spot area 800. Since the modular vehicle lamp 100 of the present embodiment has a movement detection function, wiring arrangement related to movement detection of the vehicle itself can be omitted, and the implementation difficulties and the labor costs can be reduced.

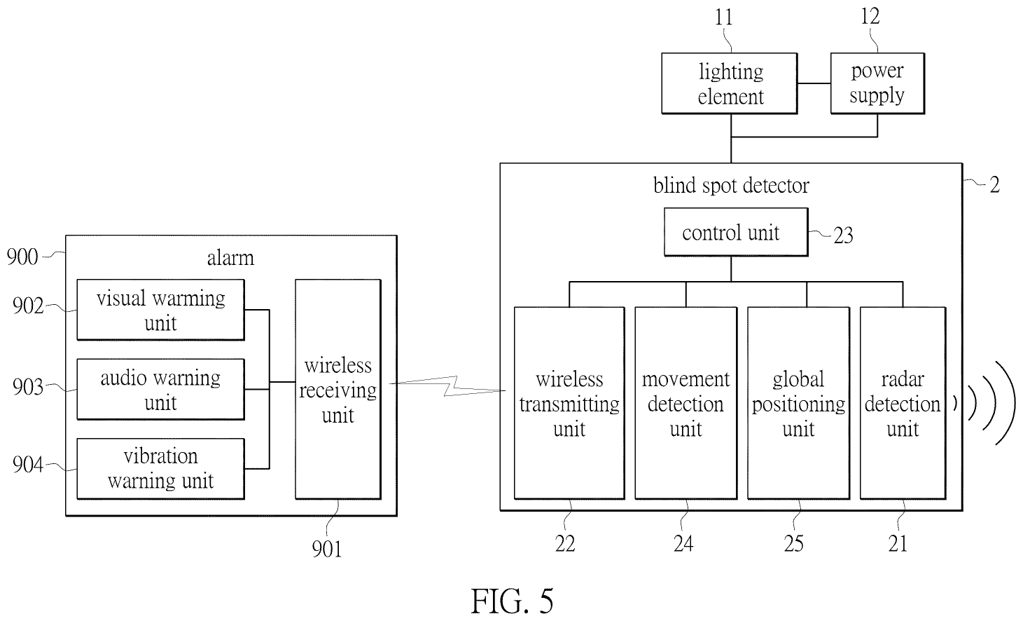

Reference is made to FIG. 1 and FIG. 2, which are to be read in conjunction with FIG. 5. In one embodiment, the blind spot detector 2 of the modular vehicle lamp 100 can further include a global positioning unit 25 (a global positioning system). The control unit 23 is coupled to the global positioning unit 25, the movement detection unit 24, the radar detection unit 21, and the wireless transmitting unit 22. After the control unit 23 receives the wake-up signal, the control unit 23 controls the radar detection unit 21 to transmit the radar detection signal and simultaneously controls the global positioning unit 25 to receive a satellite signal, and the control unit 23 calculates a vehicle speed of the vehicle 700 by the satellite signal received by the global positioning unit 25. Specifically, after the control unit 23 receives multiple satellite signals transmitted by a number of satellites via the global positioning unit 25, the control unit 23 calculates coordinate position changes of the vehicle 700 by triangulation, so as to calculate the vehicle speed of the vehicle 700. Furthermore, when the vehicle speed of the vehicle 700 is greater than or equal to a vehicle speed threshold value, the control unit 23 controls the radar detection unit 21 to continuously transmit the radar detection signal. When the vehicle speed of the vehicle 700 is less than the vehicle speed threshold value, the control unit 23 stops operation of the radar detection unit 21. The control unit 23 can also enter into sleep and standby mode after the vehicle 700 is at a complete standstill, so as to save energy. Since the modular vehicle lamp 100 of the present embodiment has a vehicle speed detection function, wiring arrangement related to vehicle speed detection of the vehicle itself can be omitted, and the implementation difficulties and the labor costs can be reduced.

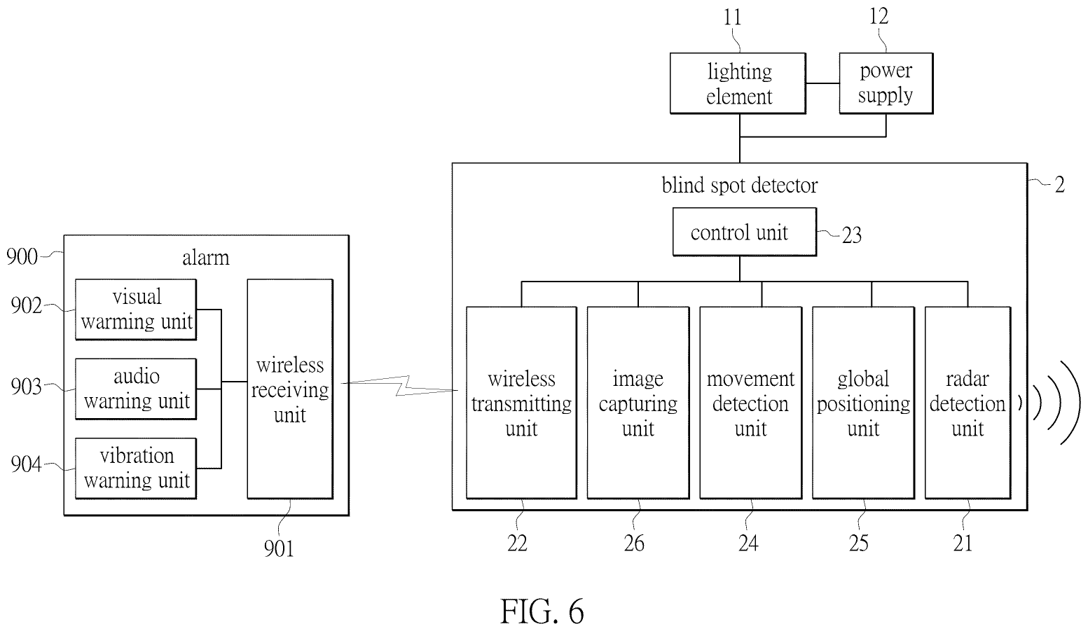

Reference is made to FIG. 1 and FIG. 2, which are to be read in conjunction with FIG. 6. The blind spot detector 2 of the modular vehicle lamp 100 can further include an image capturing unit 26 (e.g., a camera). The control unit 23 is coupled to the image capturing unit 26, the movement detection unit 24, the radar detection unit 21, and the wireless transmitting unit 22. After receiving the wake-up signal, the control unit 23 controls the radar detection unit 21 to transmit the radar detection signal. When the radar detection unit 21 detects that the moving object is present in the blind spot area 800, the control unit 23 further controls the image capturing unit 26 to capture an image of the moving object for correspondingly generating an image signal, and controls the wireless transmitting unit 22 to wirelessly transmit the warning signal and the image signal to the alarm 900 of the vehicle 700. The alarm 900 of the vehicle 700 wirelessly receives the warning signal and the image signal wirelessly transmitted by the wireless transmitting unit 22 via the wireless receiving unit 901, and the blind spot warning effect can be achieved by the visual warning unit 902 (e.g., the digital dashboard or a central display device) displaying the warning signal and the image signal. Since the modular vehicle lamp 100 of the present embodiment has an image capturing function, camera installation in the vehicle itself and wiring arrangement related thereto can be omitted, and the implementation difficulties and the labor costs can be reduced.

### Beneficial Effects of the Embodiments

In conclusion, the modular vehicle lamp having the blind spot detection function provided by the present disclosure includes a vehicle lamp body and a blind spot detector. The blind spot detector is disposed in the vehicle lamp body, and includes a radar detection unit and a wireless transmitting unit. The radar detection unit transmits a radar detection signal to detect whether or not a moving object is present in a blind spot area of a vehicle. The wireless transmitting unit is coupled to the radar detection unit, and wirelessly transmits a warning signal to an alarm of the vehicle when the radar detection unit detects that the moving object is present in the blind spot area. Hence, by configuring the modular vehicle lamp of the present disclosure to include the blind spot detector, and configuring the blind spot detector of the modular vehicle lamp to use a wireless transmission technology for transmitting the warning signal to the alarm of the vehicle and achieving a blind spot warning effect, complex wiring can be omitted, and implementation difficulties and labor costs can be effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A modular vehicle lamp having a blind spot detection function, adapted to be installed on a vehicle, the modular vehicle lamp comprising:
a vehicle lamp body; and
a blind spot detector disposed in the vehicle lamp body, wherein the blind spot detector includes:
a radar detection unit, wherein the radar detection unit transmits a radar detection signal to detect whether or not a moving object is present in a blind spot area of the vehicle; and
a wireless transmitting unit coupled to the radar detection unit, wherein, when the radar detection unit detects that the moving object is present in the blind spot area, the wireless transmitting unit wirelessly transmits a warning signal to an alarm of the vehicle.

2. The modular vehicle lamp according to claim 1, wherein the blind spot detector further includes a control unit and a movement detection unit, and the control unit is coupled to the movement detection unit, the radar detection unit, and the wireless transmitting unit; wherein the movement detection unit detects whether or not the vehicle lamp body is moving, and transmits a wake-up signal to the control unit when the vehicle lamp body is detected to be moving; and wherein, after the control unit receives the wake-up signal, the control unit controls the radar detection unit to transmit the radar detection signal, and controls the wireless transmitting unit to wirelessly transmit the warning signal to the alarm of the vehicle when the radar detection unit detects that the moving object is present in the blind spot area.

3. The modular vehicle lamp according to claim 2, wherein the blind spot detector further includes a global positioning unit, and the control unit is coupled to the global positioning unit, the movement detection unit, the radar detection unit, and the wireless transmitting unit; wherein, after the control unit receives the wake-up signal, the control unit controls the radar detection unit to transmit the radar detection signal and simultaneously controls the global positioning unit to receive a satellite signal, and the control unit calculates a vehicle speed of the vehicle by the satellite signal received by the global positioning unit; wherein, when the vehicle speed of the vehicle is greater than or equal to a vehicle speed threshold value, the control unit controls the radar detection unit to continuously transmit the radar detection signal; and wherein, when the vehicle speed of the vehicle is less than the vehicle speed threshold value, the control unit stops operation of the radar detection unit.

4. The modular vehicle lamp according to claim 2, wherein the blind spot detector further includes an image capturing unit, and the control unit is coupled to the image capturing unit, the movement detection unit, the radar detection unit, and the wireless transmitting unit; wherein, after the control unit receives the wake-up signal, the control unit controls the radar detection unit to transmit the radar detection signal; and wherein, when the radar detection unit detects that the moving object is present in the blind spot area, the control unit controls the image capturing unit to capture an image of the moving object for correspondingly generating an image signal, and controls the wireless transmitting unit to wirelessly transmit the image signal to the alarm of the vehicle.

5. The modular vehicle lamp according to claim 1, wherein the alarm includes a wireless receiving unit, a visual warning unit, and an audio warning unit, and the wireless receiving unit is coupled to the visual warning unit and the audio warning unit; and wherein, after the wireless receiving unit wirelessly receives the warning signal, the visual warning unit is controlled to transmit a visual warning message, and the audio warning unit is controlled to transmit an audio warning message.

6. The modular vehicle lamp according to claim 5, wherein the alarm further includes a vibration warning unit, and the wireless receiving unit is coupled to the vibration warning unit, the visual warning unit, and the audio warning unit; and wherein, after the wireless receiving unit wirelessly receives the warning signal, the vibration warning unit is controlled to transmit a vibration warning message.

7. The modular vehicle lamp according to claim 1, wherein the vehicle lamp body includes at least one lighting element, the blind spot detector is positioned in an area outside of the at least one lighting element of the vehicle lamp body, and the blind spot detector is coupled to a power supply of the at least one lighting element of the vehicle lamp body.
